(19) United States
(12) Patent Application Publication
(10) Pub. No.: US 2015/0340861 A1
(43) Pub. Date: Nov. 26, 2015

(54) POWER SUPPLY DEVICE

(71) Applicant: Chien-Chuan Wang, Hsinchu City (TW)

(72) Inventor: Chien-Chuan Wang, Hsinchu City (TW)

(21) Appl. No.: 14/720,606

(22) Filed: May 22, 2015

(30) Foreign Application Priority Data
May 23, 2014 (TW) 103209106

(51) Int. Cl. H02J 1/14; H02J 7/00

(52) U.S. Cl. CPC H02J 1/14; H02J 7/0052

(57) ABSTRACT

A power supply device capable of determining an operating voltage of an electronic device is disclosed. The disclosed power supply device may include a connecting unit used by the electronic device to electrically couple to the power supply device, a voltage converting unit for receiving a first voltage and converting the first voltage to a second voltage and a third voltage, a control unit connected to the connecting unit for detecting the operating voltage of the electronic device by the connecting unit and outputting a control signal based on the detected operating voltage, and a selecting unit connected to the voltage converting unit, the connecting unit, and the control unit, for receiving the control signal, the second voltage, and the third voltage before selectively outputting either the second voltage or the third voltage depending on the control signal to the electronic device.

### BACKGROUND

1. Technical Field

The present disclosure relates to a power supply device, in particular, to a power supply device capable of supplying required operating voltages to electronic devices depending on the type of the electronic devices.

2. Description of Related Art

Portable electronic devices such as laptops, personal digital assistants, mobile phones, digital cameras, and electronic gaming devices have been widely used and becoming the integral part of human life.

The portable electronic devices are always equipped with batteries for powering the portable electronic devices themselves. With the batteries only providing the limited amount of power, chargers for the electronic devices often need to be carried around just in case the batteries are running low. Such chargers are either connected to power sockets of city power or other power sources. However, considering the specification of the chargers may vary from case to case more than one charger becomes necessary rendering inconvenient the charging of the electronic devices with the charger.

### SUMMARY OF THE DISCLOSURE

In order to overcome the aforementioned deficiency, the present disclosure provides a power supply device capable of providing the electronic device with either an operating voltage or a charging voltage depending on the type of the electronic device to enhance the user experience of the electronic device.

A disclosed power supply device may be capable of determining an operating voltage of an electronic device. Such power supply device may include a connecting unit used by the electronic device to electrically couple to the power supply device, a voltage converting unit for receiving a first voltage and converting the first voltage to a second voltage and a third voltage, a control unit connected to the connecting unit for detecting the operating voltage of the electronic device by the connecting unit and outputting a control signal based on the detected operating voltage, and a selecting unit connected to the voltage converting unit, the connecting unit, and the control unit, for receiving the control signal, the second voltage, and the third voltage before selectively outputting either the second voltage or the third voltage depending on the control signal to the electronic device.

In addition to converting the first voltage to the second voltage or the third voltage through the voltage converting unit, the disclosed power supply device may further detect the type of the electronic device by the control unit. In doing so, the power supply device may enable the selecting unit to output either the second voltage or the third voltage to the electronic device, which could eliminate the need of additional chargers to be carried around while delivering the proper operating voltage to the electronic device to enhance the user experience of the electronic device.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a circuit diagram of a power supply device according to one embodiment of the present disclosure;

FIG. 2 shows a schematic diagram of a power supply device integrated with a power socket according to one embodiment of the present disclosure;

FIG. 3 shows a schematic diagram of a power supply device disposed on an extension power socket according to one embodiment of the present disclosure; and

FIG. 4 shows a schematic diagram of a power supply device disposed on an extension power cord according to one embodiment of the present disclosure.

### DESCRIPTION OF THE EXEMPLARY EMBODIMENTS

The aforementioned and other technical contents, features, and efficacies will be shown in the following detail descriptions of a preferred embodiment corresponding with the reference Figures.

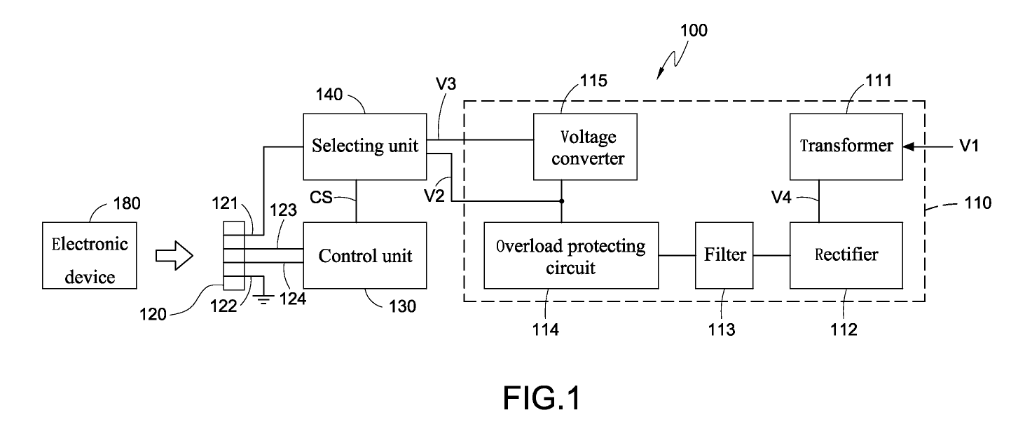

Please refer to FIG. 1 illustrating a circuit diagram of a power supply device 100 according to one embodiment of the present disclosure. The power supply device 100 may include a voltage converting unit 110, a connecting unit 120, a control unit 130, and a selecting unit 140.

The voltage converting unit 110 may be used to receive a first voltage V1, and convert the received first voltage V1 to a second voltage V2 and a third voltage V3. In one implementation, the first voltage V1 is an alternating current (AC) voltage such as 110-volt AC voltage or 220-volt AC voltage, the second voltage V2 could be a 19-volt direct current (DC) voltage, and the third voltage V3 could be a 5-volt DC voltage.

Further, the voltage converting unit 110 may also include a transformer 111, a rectifier 112, a filter 113, an overload protecting circuit 114, and a voltage converter 115. The transformer 111 may be used to receive the first voltage V1 and convert the received first voltage V1 into a fourth voltage V4. In one implementation, the fourth voltage is 19 volts.

The rectifier 112, which may be electrically coupled to the transformer 111, may receive the fourth voltage V4 and rectify the received fourth voltage V4. The filter 113, which may be electrically coupled to the rectifier 112, may be used to receive the rectified fourth voltage V4 while filtering the received rectified fourth voltage V4 before generating the filtered fourth voltage V4.

The overload protecting circuit 114, which may be electrically coupled to the filter 113, may receive the filtered fourth voltage V4 before generating the second voltage V2. In one implementation, the overload protecting circuit 114 may be a fuse despite not being limited as the result. The voltage converter 115, meanwhile, may be electrically coupled to the overload protecting circuit 114 for receiving the second voltage V2 and converting the second voltage V2 to the third voltage V3.

The voltage converter 115 may be a voltage divider, which may divide the second voltage V2 to prepare the third voltage V3. That being said, there might be other ways to implement the voltage converter 115 so long as the second voltage V2 could be properly converted to the third voltage V3.

The connecting unit 120 may be used to connect an electronic device 180. The connecting unit 120 may include two power connectors 121 and 122 and two detecting connectors 123 and 124. In one implementation, the connecting unit 120 may be a universal serial bus (USB) connecting port. The power connector 121 may be the positive power terminal “V+” of the USB connecting port, while the power connector 122 may be the negative power terminal “V−” of the USB connecting port. At the same time, the detecting connector 123 may be the positive data transmission terminal “D+” of the USB connecting port, and the detecting connector 124 may be the negative data transmission terminal “D−” of the USB connecting port. The electronic device 180 may be digital data processing apparatus including but not limited to a computer, a mobile phone, or a personal digital assistant (PDA).

The control unit 130 may be electrically coupled to the connecting unit 120 for detecting the type of the electronic device 180 through the connecting unit 120. The control unit 130 may also provide a control signal CS. When the electronic device 180 is in connection with the connecting unit 120, the control unit 130 may rely on the detecting connectors 123 and 124 of the connecting unit 120 to determine the type of the electronic device 180, in order to generate the corresponding control signal CS.

Specifically, when the control unit 130 through the two detecting connectors 123 and 124 obtains a low-voltage level signal indicative of the connection of the electronic device 180 to the detecting connectors 123 and 124 with corresponding connectors, the control unit 130 may generate the control signal CS in a low-voltage level.

On the other hand, when a high-voltage level signal is obtained by the control unit 130 through the detecting connectors 123 and 124, which indicates the lack of the connection between the corresponding connectors of the electronic device 180 and the two detecting connectors 123 and 124 the control unit 130 may generate the control signal CS in a high-voltage level.

The selecting unit 140 may be electrically coupled to the voltage converting unit 110, the control unit 130, and the connecting unit 120, for receiving the control signal CS, the second voltage V2, and the third voltage V3. The selecting unit 140 may be based on the control signal CS to selectively output the second voltage V2 or the third voltage V3 to the electronic device 180. The selecting unit 140 may be implemented in terms of a switch despite not being limited as the result.

In one implementation, when the selecting unit 140 receives the high-voltage level control signal CS the selecting unit 140 may output the second voltage (e.g., the 19-volt second voltage) to the electronic device 180 to deliver either an operating voltage or a charging voltage to the electronic device 180.

On the other hand, when the selecting unit 140 receives the low-voltage level control signal CS the selecting unit 140 may be adapted to output the third voltage (e.g., the 5-volt third voltage) to the electronic device 180, which may also serve as the operating voltage or the charging voltage for the electronic device 180. The power supply device 100 according to the present disclosure may therefore distinguish at least one electronic device 180 from others and supply either the second voltage V2 or the third voltage V3 to such electronic device 180, enhancing the user experience of the electronic device 180.

Though one connecting unit 120 has been shown in FIG. 1, the number of the connecting units 120 may vary from case to case. For example, two or more connecting units 120 may be present and they may be connected in parallel before being connected to the control unit 130 and the selecting unit 140, without affecting the inter-operations between the connecting units 120, the control unit 130, and the selecting unit 140, which may be referred to in above.

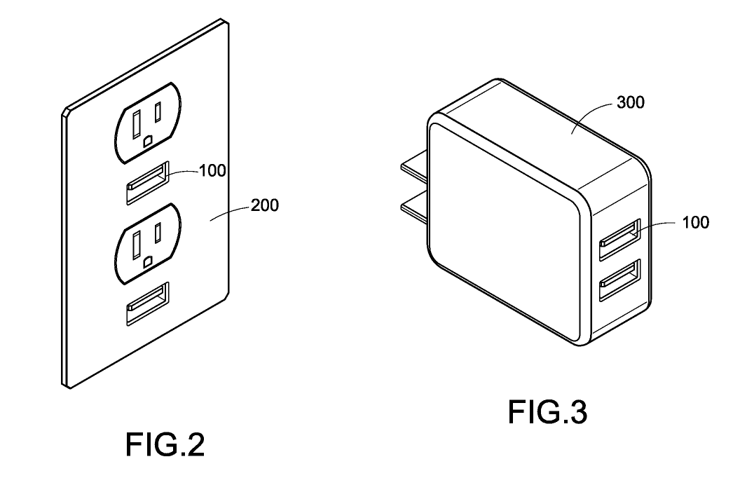

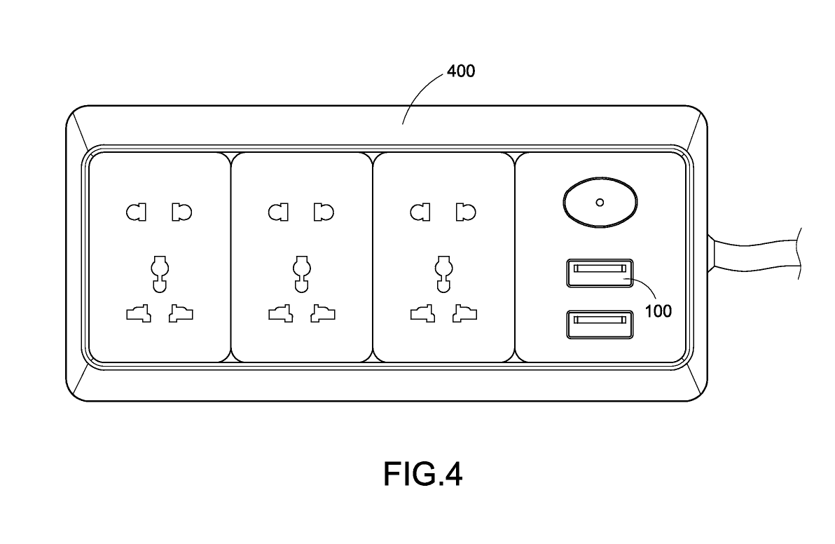

The power supply device 100 may be further integrated into a power socket panel 200 (as shown in FIG. 2), disposed on an extension power socket 300 (as shown in FIG. 3), or disposed on an extension power cord 400 (as shown in FIG. 4). Thus, the electronic device 180 operates no additional charger may be required.

The power supply device 100 according to the present disclosure may turn to the voltage converting unit 110 to convert the first voltage V1 to the second voltage V2 and the third voltage V3. The control unit 130 may detect the type of the electronic device 180 (or its operating voltage requirement) by the connecting unit 120 so that the control unit 130 may output the second voltage V2 or the third voltage V3 to the electronic device 180, which may help eliminate the need of the additional charges to be carried around for powering the batteries of the electronic devices 180. In other words, the power supply device 100 standing alone may meet the needs of the different electronic devices 180, which could significantly enhance the user experience thereof.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A power supply device capable of determining an operating voltage of an electronic device, comprising:
a connecting unit used by the electronic device to electrically couple to the power supply device;
a voltage converting unit for receiving a first voltage and converting the first voltage to a second voltage and a third voltage;
a control unit connected to the connecting unit for detecting the operating voltage of the electronic device by the connecting unit and outputting a control signal based on the detected operating voltage; and
a selecting unit connected to the voltage converting unit, the connecting unit, and the control unit, for receiving the control signal, the second voltage, and the third voltage before selectively outputting either the second voltage or the third voltage depending on the control signal to the electronic device.

2. The power supply device according to claim 1, wherein the voltage converting unit further comprises a transformer for receiving the first voltage and converting the first voltage to a fourth voltage, a rectifier electrically coupled to the transformer for receiving the fourth voltage, rectifying the received fourth voltage, and generating the rectified fourth voltage, a filter electrically coupled to the rectifier for receiving the rectified fourth voltage, filtering the received rectified fourth voltage, and generating the filtered fourth voltage, an overload protecting circuit electrically coupled to the filter for receiving the filtered fourth voltage and generating the second voltage according to the received filtered fourth voltage, and a voltage converter electrically coupled to the overload protecting circuit for receiving the second voltage and converting the second voltage to the third voltage.

3. The power supply device according to claim 2, wherein the overload protecting circuit delivers the second voltage to the selecting unit and the voltage converter delivers the third voltage to the selecting unit.

4. The power supply device according to claim 2, wherein the first voltage is an alternating current voltage, the second voltage is a 19-volt direct current voltage, and the third voltage is a 5-volt direct current voltage.

5. The power supply device according to claim 1, wherein the connecting unit is a universal serial bus (USB) connecting port further having two power connectors and two detecting connectors.

6. The power supply device according to claim 5, wherein the two power connectors are a positive power connector and a negative power connector of the USB connecting port and the two detecting connectors are positive data transmission connector and a negative data transmission connector of the USB connecting port.

7. The power supply device according to claim 6, wherein the two detecting connectors are for detecting the connection of corresponding connectors in the electronic device, when the two detecting connectors detect the connection of the corresponding connectors in the electronic device the control unit outputs the control signal in a high voltage level to the selecting unit and otherwise the control unit outputs the control signal in a low voltage level to the selecting unit.

8. The power supply device according to claim 7, wherein when receiving the control signal in the high voltage level the selecting unit outputs the second voltage to the electronic device and when receiving the control signal in the low voltage level the selecting unit outputs the third voltage to the electronic device.

9. The power supply device according to claim 1, wherein the selecting unit is a switch.

10. The power supply device according to claim 1 is selectively disposed on a power socket panel, an extension power socket, or an extension power cord.
